(19) United States
(12) Patent Application Publication
(10) Pub. No.: US 2010/0227754 A1
(43) Pub. Date: Sep. 9, 2010

(54) SINTERED AND DOPED YTTRIUM OXIDE PRODUCT

(75) Inventors: Guillaume Bernard-Granger, Mazan (FR); Christophe Sinet, Caumont Sur Durance (FR)

Correspondence Address: YOUNG & THOMPSON, 209 Madison Street, Suite 500, Alexandria, VA, 22314, US

(73) Assignee: Saint-Gobain Centre De Recherches et D'Etudes Europeen, Courbevoie (FR)

(21) Appl. No.: 12/293,824

(22) PCT Filed: Mar. 19, 2007
(86) PCT No.: PCT/IB07/50959

§ 371 Date: Jan. 6, 2009

(30) Foreign Application Priority Data
Mar. 23, 2006 (FR) 06 02512

(51) Int. Cl. C04B 35/505; C04B 35/48; C04B 35/64

(52) U.S. Cl. 501/103; 501/126; 264/604

(57) ABSTRACT

A sintered yttrium oxide product comprises: • more than 99.5% of yttrium oxide, as a percentage by weight; and • more than 50 ppma and less than 1000 ppma of a dopant selected from Zr&Ogr;₂ and/or HfO₂; the mean grain size of the doped yttrium oxide product being more than 0.03 μm and less than 5 μm.

The present invention relates to a novel product having good mechanical properties, which is transparent in the visible and infrared regions, in particular for the fabrication of furnace observation windows, of windows that are resistant to plasma corrosion, or of missile domes, and it also relates to a method of fabricating said product.

For most of those applications, several products are known:
sintered alumina products that are pure or that contain dopants are known, for example, from European patent EP-A-1 053 983, International patent application WO-A-2004/007398, and French patent application FR-A-0 513 144. Their transparency in the visible region for wavelengths shorter than 0.6 μm [micrometers] and their transparency in the infrared for wavelengths longer than 5 μm are limited, however. Further, their resistance to chemical type corrosive stress is low;
sapphire, which has good transparency in the visible region (0.4 μm-0.8 μm) and in the near and median infrared (0.8 μm to 5 μm). However, the transparency of sapphire is poor beyond 5 μm. Further, its cost is prohibitive and it has poor resistance to chemical type corrosive stress;
products based on yttrium oxide (Y₂O₃) have good transparency in the infrared for wavelengths of up to 7 μm, fairly good transparency in the visible region and a very low emittance compared with sapphire for wavelengths longer than 2.5 μm.

Pure yttrium oxide products are known, for example from U.S. Pat. No. 5,004,712 or US 2004/0159984. The article “Non-doped Y₂O₃ for 3 μm-5 μm IR transmission” by Sumitomo Electric Industries (SPIE Vol 1326, pp 48 to 53, Window and dome technologies and materials II, 1990), details the impact of the grain size of a non-doped yttrium oxide product on the properties of mechanical strength and transparency.

Yttrium oxide products doped with lanthanum oxide (U.S. Pat. No. 4,115,134), alumina (U.S. Pat. No. 4,166,831, U.S. Pat. No. 4,098,612), or titanium oxide (U.S. Pat. No. 5,308,809) are also known. Finally, U.S. Pat. No. 3,545,897 describes products doped with ThO₂, ZrO₂, HfO₂ or a combination thereof and may contain in the range 2 mol % to 15 mol %, preferably in the range 5 mol % to 12 mol % of ZrO₂.

The mean grain size of products based on yttrium oxide is generally more than 10 μm and frequently more than 100 μm, which limits their mechanical characteristics. Further, while those products have good transparency in the infrared region, transparency in the visible region may sometimes be limited.

Thus, there is a need for a product with good transparency in the visible and infrared regions, with good mechanical properties, and of reduced cost.

In accordance with the invention, this aim is achieved by a sintered yttrium oxide product comprising:
more than 99.5% yttrium oxide, as a percentage by weight; and
more than 50 ppma [parts per million atomic], preferably more than 100 ppma and less than 1000 ppma, preferably less than 500 ppma, of a dopant selected from ZrO₂, HfO₂ and mixtures thereof;
   the mean grain size of the doped yttrium oxide product being more than 0.03 μm and less than 5 μm, preferably less than 2 μm, more preferably less than 1 μm. Preferably, the density of the product is more than 99.95% of the theoretical density of the mixture of yttrium oxide and dopant.

Preferably, the dopant is zirconia (ZrO₂), preferably stabilized, more preferably stabilized with yttrium.

As can be seen below in more detail from the remainder of the description, the product of the invention advantageously has high mechanical strength, in particular good hot bending strength, and very good transparency in the visible region (from 0.4 μm) and in the infrared region (up to 7 μm).

Further, the transparency of the product of the invention may also be considerably improved by annealing the product in a suitable manner, which is known per se, to reduce the number of oxygen voids. The invention thus provides a sintered yttrium oxide product of the invention that has undergone said annealing, regardless of the method used to fabricate the product of the invention, and a method of fabricating a product of the invention that includes an annealing step suitable for reducing the number of oxygen voids. Said annealing is preferably carried out in an air or oxygen atmosphere. The results have proved to be particularly remarkable in an oxygen atmosphere. The term “oxygen atmosphere” means any atmosphere containing more than 99% by volume of oxygen.

In the product, this results in a reduction in the number of oxygen voids and a remarkable improvement in RIT (real in-line transmittance, measured here on a 1 mm [millimeter] thick sample). The product of the invention thus has the following preferred characteristics:
a transmittance in the range 0.4 μm to 0.5 μm, preferably in the range 0.4 μm to 0.6 μm, of more than 30%, preferably more than 40%, more preferably more than 60% and most preferably more than 70%; and/or
a transmittance in the range 0.5 μm to 0.7 μm of more than 40%, preferably more than 50%, more preferably more than 60%, still more preferably more than 65% and most preferably more than 70%; and/or
a transmittance in the range 0.6 μm to 0.8 μm of more than 55%, preferably more than 65%, more preferably more than 70%; and/or
a transmittance at 1 μm of more than 50%, preferably more than 60%, more preferably 70% or more, and even more than 80%; and/or
a transmittance at 1.6 μm of more than 70%, preferably more than 75%, more preferably more than 80%; and/or
a transmittance at 2 μm of more than 75%, preferably more than 78%, more preferably more than 80%.

Preferably, the product of the invention has a transmittance of more than 70%, preferably more than 80%, in the range 0.4 μm to 0.8 μm, preferably in the range 0.4 μm to 6 μm, more preferably in the range 0.4 μm to 6.5 μm.

Preferably, the product of the invention also has one or more of the following optional characteristics:
the microstructure of the product of the invention has a surface density, Fv, of “coarse grains” which is less than 4% by area, preferably less than 2% by area, more preferably less than 0.1% by area. Preferably, the product of the invention has no grains with a size more than double the mean size of the other grains.

Advantageously, this characteristic endows the product with remarkable mechanical properties, especially as regards bending.

The mean grain size is less than 2 μm, or even less than 1 μm.

The product has a mechanical strength at 1000° C., measured by three-point bending, of more than 160 MPa [megapascal], preferably more than 200 MPa, more preferably more than 250 MPa, still more preferably more than 280 MPa.

As can be seen in the description below, a product of the invention may be obtained by carrying out a fabrication method of the invention comprising the following steps in succession:

a) preparing a slip from an yttrium oxide powder with a mean aggregate size in the range 0.1 μm to 3 μm, preferably about 1 μm, the mean size of the elementary particles making up said aggregates being in the range 0.02 μm to 0.5 μm, preferably about 0.1 μm, and a powder of a dopant selected from ZrO₂, HfO₂ and mixtures thereof, introduced in the form of said oxides or one or more precursors of said oxides, the mean size of the elementary particles of the dopant powder being less than or equal to the mean size of the elementary particles of the yttrium oxide powder;

b) casting the slip into a porous mold, then drying and unmolding to obtain a green part;

c) drying the unmolded green part;

d) debinding at a temperature in the range 350° C. to 800° C.;

e) sintering at a temperature in the range 1350° C. to 1700° C. to obtain a sintered product with a density of at least 92% of the theoretical density of the product obtained at the end of step f); and

f) hot isostatic pressing, “HIP”, at a temperature in the range 1250° C. to 1675° C. at a pressure in the range 5 MPa to 300 MPa, to obtain a product termed a “dense sintered product”. The hot isostatic pressing is carried out at a temperature below the sintering temperature.

Preferably, the hot isostatic pressing temperature is 20° C. to 100° C., preferably 50° C. to 100° C. below the sintering temperature;

the amounts of yttrium oxide and dopant/dopant precursor(s) in the slip prepared in step a) being determined so that the sintered product obtained at the end of step f) is in accordance with the invention.

The inventors have discovered that in a method of the invention employing casting a slip, hot isostatic pressing at a temperature below the sintering temperature reduces the surface density of coarse grains, Fv. This additional characteristic means that the microstructure of the product of the invention may comprise less than 4% by area of coarse grains (Fv), and may even comprise substantially no coarse grains. This results in remarkable bending strength.

As explained above, the dense sintered product obtained at the end of step f) preferably undergoes a additional annealing step g).

Preferably, said annealing is carried out in air or, as is preferable, in oxygen, at a temperature in the range 800° C. to 1500° C. and for a period in the range 0.5 hours to 24 hours to reduce the number of oxygen voids in the product. Advantageously, the reduction in the number of oxygen voids in the product improves transparency, in particular in the visible region.

In a variation, annealing is carried out during step f). Hot isostatic pressing is then preferably carried out in an oxygen atmosphere. Although this second implementation is not preferred for safety reasons, it has the advantage of simplifying the method, annealing being simultaneous with HIP densification.

Annealing in oxygen can advantageously produce a product of the invention having a transmittance of more than 70%, or even greater than 80%, in the range 0.4 μm to 0.8 μm, preferably in the range 0.4 μm to 6 μm.

Preferably, the method of the invention comprises one and preferably more of the following optional characteristics:
the mold is dried prior to casting the slip;
the temperature during the whole of step b) is in the range 20° C. to 25° C.;
the pressure of the slip inside the mold is in the range 1 bar to 1.5 bar;
the moisture content of the environment surrounding the mold is kept in the range 45% to 55%, preferably in the range 48% to 52%, for the whole of step b).

Finally, the invention provides the use of a product of the invention or of a product fabricated or capable of being fabricated by a method in accordance with the invention as a furnace observation window, as a missile dome or as a plasma corrosion-resistant window.

Other characteristics and advantages of the invention become apparent from the following description made with reference to FIGS. 1 and 2 which show graphs of the real in-line transmittance (“RIT”, as a percentage, up the ordinate) of various products as a function of the wavelength of incident radiation (“λ”, in μm, along the abscissa).

In the figures, the curves shown as a solid black line represent the measurements obtained with a pure yttrium oxide product, with a mean grain size of 6 μm; the gray curves show the measurements obtained with an yttrium oxide product doped with 300 ppma of zirconia, with a mean grain size of 2.8 μm (product of Example 1), and the curves in black dashed lines show the measurements obtained with an yttrium oxide product doped with 300 ppma of zirconia, with a mean grain size of 0.9 μm (product of Example 2).

The term “theoretical density” of a composition constituted by yttrium oxide and dopant means the density of a mass constituted by said yttrium oxide and said dopant and having a porosity of zero.

A “powder” is a set of particles which themselves may be agglomerates of “elementary particles”.

The term “grains” means crystalline polyhedra constituting the finished product.

The term “size” of a grain or a particle means its mean dimension.

Conventionally, the term “mean particle or grain size” of a mixture of particles or a set of grains means the size dividing the particles of that mixture or the grains of that set into first and second populations that are equal in number, said first and second populations comprising only particles or grains having a size that is respectively greater than or less than the mean size.

The term “dopant precursor” means a constituent suitable for providing a dopant during fabrication of a sintered product of the invention.

A “coarse grain” is a grain with a size that is more than double the mean size of the other grains, the size being measured by analysis carried out on images obtained by scanning electron microscopy.

In step a) of the fabrication method of the invention, a slip is prepared from a powder of yttrium oxide and dopant/dopant precursor. The dopant may be a powder of zirconia, HfO₂, or a mixture of these two species. In particular, zirconia turns out to provide the product of the invention with remarkable transparency.

Other species in the slip that may be found in the final product are impurities necessarily introduced with yttrium oxide and dopant powders, or during the various steps of the method. Their amounts are considered to be insufficient to modify the advantageous properties of the product of the invention.

The term “slip” means a substance formed by a suspension of particles in a liquid, generally water or an organic solvent (for example alcohol), with or without additives such as dispersing agents, deflocculating agents, polymers, etc. Preferably, the slip includes a temporary binding agent, i.e. an agent that is eliminated from the product during sintering.

Slip fabrication is a technique that is very well known to the skilled person. In particular, the skilled person knows how to determine the amounts of yttrium oxide and dopant/dopant precursor(s) and the nature and quantity of additives in the slip to obtain a product of the invention at the end of step f).

Typically, the purity of the yttrium oxide powder used is more than 99.97% by volume.

Similarly, the mean yttrium oxide grain size of the final product depends, as is known, on the sintering conditions, on the temperature of the HIP treatment, and on the mean size of the elementary particles of the yttrium oxide powder used in step a). For the mean size of said grains to be in the range 0.03 μm to 5 μm, the mean size of the elementary particles of the yttrium oxide powder used is selected so as to be in the range 0.02 μm to 0.5 μm. Preferably, the mean elementary particle size of the powder used is selected so that the mean particle size of the yttrium oxide grains of the final product is more than 0.03 μm and less than 5 μm, preferably less than 2 μm, more preferably less than 1 μm.

Preferably, in step a), the dopant is added deliberately, i.e. systematically and methodically.

The slip may be fabricated in a receptacle using techniques that are known to the skilled person, by mixing and homogenizing the powders and the desired quantity of liquid.

Preferably, the slip comprises more than 60% dry matter.

Also preferably, the receptacle containing the slip may temporarily be placed under reduced pressure, preferably reduced by more than 0.5 bar, to eliminate residual air bubbles from the slip to as great an extent as possible.

Preferably, the mold is pre-dried. Advantageously, the setting time during drying step b) is reduced.

The temperature during the operations of casting and forming the preform is preferably kept in the range 20° C. to 25° C.

The inventors have discovered that casting a slip can endow the product with a density which is more than 99.95% of the theoretical density after the complete fabrication cycle, and that very high density improves transparency.

After filling the mold, at least one porous wall of the mold absorbs at least part of the liquid from the slip. Complete filling of the mold and evacuation may be encouraged by pressurizing the inside of the mold, for example using a feed column adapted to the geometry of the part. Preferably, the pressure of the slip inside the mold is in the range 1 bar to 1.5 bar. Advantageously, the density of the green part is enhanced thereby, and/or this renders forming parts with a thickness of more than 3 millimeters possible.

Also preferably, the moisture content of the air surrounding the mold is kept in the range 45% to 55%, preferably in the range 48% to 52%, for the whole of step b). Advantageously, the drying time is controlled thereby.

As the liquid is evacuated, the particles of yttrium oxide and dopant become immobilized relative to each other. Said immobilization is termed “setting the preform”. The residual porosity between the immobilized particles allows liquid to pass through, however.

Additional slip is preferably introduced into the mold as the liquid is absorbed. Advantageously, part of the volume left vacant by the liquid is thus filled with particles of yttrium oxide and dopant from the additional slip.

After the moisture level in the part in the mold drops below 2%, it is considered to have undergone sufficient drying to ensure its integrity and to hold its shape during handling after unmolding. The mold then contains a “preform” and the feeding of additional slip is stopped. The preform is then unmolded to obtain an unfired or “green” part.

In step c), the green part undergoes additional drying, for example by storage in an oven under controlled temperature and moisture conditions, using conventional methods.

In step d), the dried green part undergoes debinding, preferably in air, at a temperature in the range 350° C. to 800° C. Debinding is an operation which is known per se, intended to eliminate organic chemicals from the green part.

In step e), the dried and debound green part or “blank” is sintered, i.e. densified and consolidated by a heat treatment.

In conventional manner, the blank is placed in a medium, preferably air, at a temperature that varies as a function of time in accordance with a predetermined cycle. The heat treatment comprises a stage of ramping up the temperature of the medium surrounding the part, then a stage of keeping the temperature constant, or “sintering stage”, at a temperature in the range 1350° C. to 1700° C., then finally a temperature ramp-down stage. Sintering may be carried out in a conventional furnace, or by SPS (spark plasma sintering), or by MWS (microwave sintering).

The sintering stage preferably lasts in the range 0 (no stage) to 20 hours. In a conventional furnace, the temperature ramp-up/down rates are in the range 50° C./hour to 900° C./hour. For sintering by SPS or MWS, they are in the range 20° C. to 300° C./minute.

Sintering causes shrinkage and thus densification of the part. It is possible to obtain a density following sintering of 92% or more of the theoretical density. This limit is considered by the skilled person to be necessary in order to obtain, after the next step f) (HIP), a density of more than 99.95% of theoretical density.

In step f), after cooling, the sintered part resulting from sintering the blank undergoes a post-pressure heat treatment termed “HIP” (hot isostatic pressing), preferably in an inert gas, for example in argon.

Hot isostatic pressing (HIP) is carried out in a chamber at a temperature in the range 1250° C. to 1675° C., and at a pressure in the range 5 MPa to 300 MPa. The temperature in the chamber is preferably less than the sintering temperature. Also preferably, the temperature in the chamber is 20° C. to 100° C. lower than the sintering temperature.

The hot isostatic pressing (HIP) operation can further increase the density of the parts by eliminating any residual porosity possibly present after sintering, and closing up certain structural defects of the micro-crack type, thereby improving the mechanical behavior of the ceramic parts.

Debinding and sintering may be carried out in an atmosphere which is other than air. In contrast, for safety reasons, hot isostatic pressing is preferably carried out in an inert atmosphere, preferably in argon.

A sintered product of the invention is obtained at the end of step f). Said product then undergoes an additional annealing step g).

Electromagnetic radiation may be transmitted, reflected or diffused. Conventionally, a material is termed “transparent” to radiation when it is capable of in-line transmission of that radiation, i.e. when it has high RIT (real in-line transmittance). For a pure material, when the measured RIT values are close to the theoretical RIT values calculated by taking the refractive index of the material into account, diffusion is negligible. A pure material is more “transparent” when it has a high RIT value and low reflectivity.

In the tests below, in order to determine transparency, the parts were precision ground and polished to a mirror finish. At the end of that preparation, the products had average roughness (Ra) of <10 nm and thickness of 1 mm. The RIT was then measured for wavelengths in the range 0.4 μm to 10 μm.

The grain size was measured by a “mean linear intercept” method based on an analysis of images obtained by scanning electron microscopy starting from polished mirrors that had been heat-attacked (at a temperature of 50° C. to 80° C. below the temperature of the HIP treatment) in order to reveal the grain joints. A measurement method of that type is described in ASTM NPA 04102 (American linear intercept method). The results obtained with that method were multiplied by a correction coefficient of 1.2 to take the three-dimensional aspect into account.

The mechanical strength of the sintered parts was measured by hot three-point bending, i.e. at 1000° C., on specimens with dimensions of 24 mm*4 mm*2 mm with a distance between supports of 20 mm and a crossing rate of 0.5 mm/min, using a Lloyd press, model number LR150K.

Toughness was measured by an indentation method and by measuring the length of the cracks created.

The density of a product was evaluated as follows: the mean grain size and the mean pore size as well as a graph showing the RIT transparency as a function of the incident wavelength (“real curve”) were all determined from measurements made on the product. In conventional manner, the sizes may be determined by the ASTM NPA 04102 (American linear intercept method) applied to a polished section of the product.

A theoretical curve representing the RIT transparency as a function of the incident wavelength for a theoretical material identical to that of the product, but having a density of 100% (zero residual porosity), was then traced using a model, for example a model adapted from the model described in “Transparent alumina: a light scattering model” by R. Apetz and M. P. B. Van Bruggen, J. Am. Ceram. Soc., 86, 480-486 (2003). That model provided, for alumina, a determination of the in-line transmittance as a function of residual porosity, of the mean grain size and of the mean pore size. Since the yttrium oxide product of the invention crystallizes in a cubic structure, it is not necessary to take into account the “mean grain size” and “birefringence” parameters. Therefore, the model mentioned above may be used directly to evaluate the in-line transmittance of the yttrium oxide products of the invention, using the residual porosity and the mean pore size as parameters, and replacing the parameters “refraction index as a function of radiation length” and “scattering cross section of one sphere” (generally called “Csca”, which unit is m²) of alumina by those of yttrium oxide.

The distance between the two curves (theoretical transparency and actually measured transparency of a product) is the consequence of the presence of residual porosity. In the model mentioned above, by increasing the value for the residual porosity while maintaining the value for the mean pore size at a value identical to the corresponding size measured on the product, the curve traced using the model draws closer to the theoretical curve until they are superimposed. “Superimposition” is considered to have occurred when the correlation coefficient R² tends to a maximum of 1 and is more than 0.98 throughout. The value of the residual porosity used to trace the theoretical curve coming into superimposition with the real curve is an evaluation of the real residual porosity of the product. The density of the product may then be determined from that evaluation.

The method used to measure the surface density of coarse grains, Fv, is as follows: a section of product was polished to obtain a mirror quality polish. After polishing, thermal attack at a temperature 50° C. to 80° C. below the sintering temperature was carried out for 0.5 hours. A photograph with total area AT was then taken using a scanning electron microscope. In this photograph, the large grains were polygonized by image analysis and the total area represented by the coarse grains, AGG, was calculated. The “surface density” of the coarse grains, Fv, is the ratio of the total area of the coarse grains AGG divided by the total area AT, multiplied by 100.

Abnormal growth was assumed when Fv was more than 4%.

The following non-limiting examples are given by way of illustration of the invention.

Samples were prepared using a method in accordance with the invention, as follows.

### EXAMPLE 1

### Sintered Yttrium Oxide Product Containing 300 ppm Atomic of Zro₂ and with a Mean Grain Size of 2.8 μm

A slip in the form of a suspension with 65% dry matter content was prepared by mixing, in a drum grinder:
a dispersing agent in a nature and quantity determined so that its action on the dispersion of particles of yttrium oxide powder was optimal;
an organic binder;
yttrium oxide powder with a purity of more than 99.97% and with a mean aggregate size, d50, of 1 μm, the aggregates being constituted by elementary particles with a d50 of 0.1 μm; and
zirconium oxide (ZrO₂) powder stabilized with yttrium oxide (3 mol %) constituted by elementary particles with a d50 of 0.05 μm, introduced in an amount of 300 ppm atomic (ppma).

The grinding beads were of 99% vol alumina. The mixing time was 24 hours.

The prepared slip was deaerated and cast into a porous mold which had been in an oven at 50° C. for 48 h [hours]. During casting and holding in the mold, the temperature was kept at 23° C., the ambient air being at atmospheric pressure and having a humidity of 50%.

After initial drying in the mold, then unmolding, the green part underwent additional drying and debinding in air for 3 h at 480° C., and was then left to stand for 2 days under ambient temperature and pressure conditions.

The blank obtained was then sintered in air at 1600° C. for 6 hours. The sintered part then underwent hot isostatic pressing (HIP) in argon at 1550° C. for 15 hours.

The sintered product obtained finally underwent an annealing treatment, in air at 1200° C. for 12 hours to reduce the number of oxygen voids and to improve its transparency, especially in the visible region.

### EXAMPLE 2

### Sintered Yttrium Oxide Product Containing 300 ppm Atomic of ZrO₂ and with a Mean Grain Size of 0.9 μm

A slip in the form of a suspension with 65% dry matter content was prepared by mixing, in a drum grinder:
a dispersing agent in a nature and quantity determined so that its action on the dispersion of particles of yttrium oxide powder was optimal;
an organic binder;
yttrium oxide powder with a purity of more than 99.97% and with a mean aggregate size, d50, of 1 μm, constituted by elementary particles with a d50 of 0.1 μm; and
zirconium oxide powder (ZrO₂) stabilized with yttrium oxide (3 mol %) constituted by elementary particles with a d50 of 0.05 μm, introduced in an amount of 300 ppm atomic.

The grinding beads were of 99% vol alumina. The mixing time was 24 hours.

The prepared slip was deaerated and cast into a porous mold which had been in an oven at 50° C. for 48 h. During casting and holding in the mold, the temperature was kept at 23° C., the ambient air being at atmospheric pressure and having a moisture content of 50%.

After initial drying in the mold, then unmolding, the green part underwent additional drying and debinding in air for 3 h at 480° C., then was left to stand for 2 days under ambient temperature and pressure conditions.

The blank obtained was then sintered in air at 1600° C. for 1 hour. The sintered part then underwent hot isostatic pressing (HIP) in argon at 1550° C. for 15 hours.

The sintered product obtained finally underwent an annealing treatment, in oxygen at 1200° C. for 12 hours to reduce the number of oxygen voids and to improve its transparency, especially in the visible region.

Table 1 below provides the results of tests carried out on the products of Examples 1 and 2 and on sapphire (orientation 0°).

| | Sapphire | Example | Example |
|---|---|---|---|
| | 0° orient. | 1 | 2 |
| Mean grain size (μm) | — | 2.8 | 0.9 |
| Density (% relative to | — | 100% | 100% |
| theoretical density) | | | |
| Abnormal growth | — | No | No |
| Toughness, MPa · m^{-1/2} | 0.9 | 2.2 | 2.2 |
| 3-point bending strength | 150 | 190 | 300 |
| at 1000° C. (MPa) | | | |
| Corrosion resistance for | Poor | Good | Good |
| plasma window application | | | |
| RIT (%) at 0.5 μm | 83 | 52 | 81.7 |
| RIT (%) at 2 μm | 85.4 | 78.4 | 83 |
| RIT (%) at 4 μm | 86.1 | 83.4 | 82.8 |
| RIT (%) at 6.5 μm | 10.3 | 82 | 83 |

It can be seen that the measured bending strength at 1000° C. of the sintered products of the invention is highly satisfactory, better than that of sapphire which is currently used in missile dome or observation window applications.

FIGS. 1 and 2 show real on-line transmittance measurements for different products as a function of the wavelength of the incident radiation, in the range 0.4 μm to 10 μm. The test products were:
a pure sintered yttrium oxide product, the mean grain size being 6 μm;
a sintered yttrium oxide product doped with 300 ppma of zirconia, the mean size of the yttrium oxide grains being 2.8 μm, the product having undergone annealing in air (Example 1); and
a sintered yttrium oxide product doped with 300 ppma of zirconia, the mean grain size of the yttrium oxide being 0.9 μm, the product having undergone a step of annealing in oxygen (Example 2).

FIGS. 1 and 2 confirm the remarkable transparency of the products of the invention, both in wavelengths in the visible region (0.4 μm to 0.8 μm) and in the infrared (0.8 μm to 7 μm), in particular for the product of Example 2.

As can clearly be seen here, the invention provides very dense products with fine grains that are strong and have very good transparency both in the infrared region and in the visible region.

Clearly, the present invention is not limited to the implementations described, which are provided by way of non-limiting illustrative examples.

1-24. (canceled)

25. A sintered yttrium oxide product comprising:
more than 99.5% yttrium oxide, as a percentage by weight; and
more than 50 ppma and less than 1000 ppma of a dopant selected from ZrO₂, HfO₂, and mixtures thereof;
the mean grain size being more than 0.03 μm and less than 5 μm.

26. A sintered yttrium oxide product according to claim 25, having a density of more than 99.95% of the theoretical density of the mixture of yttrium oxide and dopant.

27. A sintered yttrium oxide product according to claim 25, having a real in-line transmittance (RIT), measured on a sample with a thickness of 1 mm:
of more than 30% for a wavelength of incident radiation in the range 0.4 μm to 0.5 μm; and/or
of more than 40% for a wavelength of incident radiation in the range 0.5 μm to 0.7 μm; and/or
of more than 55% for a wavelength of incident radiation in the range 0.6 μm to 0.8 μm; and/or
of more than 50% for a wavelength of incident radiation of 1 μm; and/or
of more than 70% for a wavelength of incident radiation of 1.6 μm; and/or
of more than 75% for a wavelength of incident radiation of 2 μm.

28. A sintered yttrium oxide product according to claim 27, having a real in-line transmittance (RIT), measured on a sample with a thickness of 1 mm:
of more than 60% for a wavelength of incident radiation in the range 0.4 μm to 0.5 μm; and/or
of more than 65% for a wavelength of incident radiation in the range 0.5 μm to 0.7 μm; and/or
of more than 65% for a wavelength of incident radiation in the range 0.6 μm to 0.8 μm; and/or
of more than 70% for a wavelength of incident radiation of 1 μm; and/or
of more than 75% for a wavelength of incident radiation of 1.6 μm; and/or
of more than 78% for a wavelength of incident radiation of 2 μm.

29. A sintered yttrium oxide product according to claim 28, having a real in-line transmittance (RIT), measured on a sample with a thickness of 1 mm:
of more than 70% for a wavelength of incident radiation in the range 0.4 μm to 0.5 μm; and/or
of more than 70% for a wavelength of incident radiation in the range 0.5 μm to 0.7 μm; and/or
of more than 70% for a wavelength of incident radiation in the range 0.6 μm to 0.8 μm; and/or
of more than 80% for a wavelength of incident radiation of 1 μm; and/or
of more than 80% for a wavelength of incident radiation of 1.6 μm; and/or
of more than 80% for a wavelength of incident radiation of 2 μm.

30. A sintered yttrium oxide product according to claim 25, comprising more than 100 ppma and less than 500 ppma of dopant.

31. A sintered yttrium oxide product according to claim 25, in which the zirconia (ZrO₂) is stabilized.

32. A sintered yttrium oxide product according to claim 31, in which the zirconia (ZrO₂) is stabilized with yttrium.

33. A sintered yttrium oxide product according to claim 25, in which the mean grain size is less than 2 μm.

34. A sintered yttrium oxide product according to claim 33, in which the mean grain size is less than 1 μm.

35. A sintered yttrium oxide product according to claim 25, having transmittance of more than 70% for incident radiation with wavelengths in the range 0.4 μm to 0.8 μm.

36. A sintered yttrium oxide product according to claim 25, having coarse grain surface density (Fv) of less than 4% by area.

37. A sintered yttrium oxide product according to claim 36, having coarse grain surface density (Fv) of less than 2% by area.

38. A sintered yttrium oxide product according to claim 37, having coarse grain surface density (Fv) of less than 0.1% by area.

39. A sintered yttrium oxide product according to claim 25, having mechanical strength at 1000° C., measured by three-point bending, of more than 160 MPa.

40. A sintered yttrium oxide product according to claim 39, having mechanical strength at 1000° C., measured by three-point bending, of more than 250 MPa.

41. A sintered yttrium oxide product according to claim 40, having mechanical strength at 1000° C., measured by three-point bending, of more than 280 MPa.

42. A method of fabricating a sintered yttrium oxide product according to claim 25, comprising the following steps in succession:
a) preparing a slip from an yttrium oxide powder with a mean aggregate size in the range 0.1 μm to 3 μm, the mean size of the elementary particles making up said aggregates being in the range 0.02 μm to 0.5 μm, and a powder of a dopant selected from ZrO₂, HfO₂ and mixtures thereof, introduced in the form of said oxides or one or more precursors of said oxides, the mean size of the elementary particles of the dopant powder being less than or equal to the mean size of the elementary particles of the yttrium oxide powder;
b) casting the slip into a porous mold, then drying and unmolding to obtain a green part;
c) drying the unmolded green part;
d) debinding at a temperature in the range 350° C. to 800° C.;
e) sintering at a temperature in the range 1350° C. to 1700° C. to obtain a sintered product with a density of at least 92% of the theoretical density of the product obtained at the end of step f); and
f) hot isostatic pressing, termed “HIP”, at a temperature in the range 1250° C. to 1675° C. at a pressure in the range 5 MPa to 300 MPa;
g) annealing at a temperature in the range 800° C. to 1500° C. and for a period in the range 0.5 to 24 hours to reduce the number of oxygen voids in the product;
the amounts of yttrium oxide and dopant/dopant precursor(s) in the slip prepared in step a) being determined so that the sintered product obtained at the end of step g) is in accordance with claim 1.

43. A fabrication method according to claim 42, in which annealing is carried out in oxygen.

44. A fabrication method according to claim 42, hot isostatic pressing being carried out at a temperature which is lower than the sintering temperature.

45. A fabrication method according to claim 44, in which the hot isostatic pressing temperature is 20° C. to 100° C. lower than the sintering temperature.
